(19) United States
(12) Patent Application Publication
(10) Pub. No.: US 2013/0282498 A1
(43) Pub. Date: Oct. 24, 2013

(54) ROUTER ADVERTISEMENT FOR MULTIPLE STACK SCENARIO

(71) Applicant: Jouni Korhonen, Riihimaki (FI)

(72) Inventor: Jouni Korhonen, Riihimaki (FI)

(73) Assignee: NOKIA SIEMENS NETWORKS OY, Espoo (FI)

(21) Appl. No.: 13/978,040

(22) PCT Filed: Jan. 3, 2011
(86) PCT No.: PCT/EP2011/050019

§ 371 Date: Jul. 2, 2013

(51) Int. Cl. G06Q 30/02

(52) U.S. Cl. CPC G06Q 30/0277
USPC 705/14.73

(57) ABSTRACT

It is provided an apparatus, comprising advertisement receiving means adapted to receive an advertisement message according to a first network layer protocol, wherein the advertisement message comprises a flag, a network layer address according to a second network layer protocol different from the first network layer protocol, and a first link layer address; flag detecting means adapted to detect if the flag is set in the advertisement message; routing table setting means adapted to set the first link layer address as a router address in a routing table of the second network layer protocol if the flag is set; and directing means adapted to direct a message of the second network layer protocol to the router address as a first hop router.

### FIELD OF THE INVENTION

The present invention relates to an apparatus, a method, a system, and a computer program product related to router advertisement. More particularly, the present invention relates to an apparatus, a method, a system, and a computer program product for steering traffic using router advertisements of a multiple-stack capable router.

### BACKGROUND OF THE INVENTION

Mobile phones, or more generally “user equipments” (UE) equipped with 3GPP, WLAN and Bluetooth radio, which may be simultaneously enabled and used for data communication are examples of hosts with multiple interfaces. In particular, in some user equipments, several network layer stacks such as IPv4 and IPv6 (IP: internet protocol) may be employed.

IPv6 has a standardized way of prioritizing default routers and configuring more specific routes using router preferences and more specific route options in Router Advertisements (RA) as defined in [RFC4191] (RFC: Request for Comments). Originally [RFC4191] was designed for a single interface and a model where routers that the RAs concern are all on the same link.

However, experimental tests have shown that [RFC4191] can be used in multiple interfaces scenario, as a tool for directing specific flows between different access technologies based on the assumption that one interface is a “commanding” interface. In a cellular environment, such as Global Packet Radio System (GPRS) and Enhanced Packet core (EPC), the commanding interface may be the 3GPP radio access (3GPP: 3^{rd} generation partnership program), which can be configured to be the only interface in an UE that accepts [RFC4191] information injected from the network. This configuration may be applied for WLAN offload and similar deployment scenarios for IPv6-only traffic. In such a scenario, a packet data network gateway (PDN-GW) or gateway GPRS support node (GGSN) is the sender of the traffic steering RAs. The RA may be sent at any time over IPv6 PDN connection/PDP context, also during the bearer establishment where the RA that configures an IPv6 prefix for the UE is sent.

It is mandatory for any IPv6 capable host to implement Neighbor Discovery Protocol, which involves the processing of Router Advertisement (RA) and Router Solicitation (RS) messages. The [RFC4191] solution works for IPv6 only traffic. Router Advertisement may be sent by an application level process, too, that is not an integral part of the IP stack.

The functionality using Router Advertisements and Neighbor Discovery Protocol is defined for IPv6-only cases but in Multiple-Stack cases, for example in a dual-stack case where the routers have both IPv6 and IPv4 router functions/interfaces, there is no way to instruct the host how to handle IPv4 flows using IPv6 Neighbor Discovery Protocol mechanisms. That is, for Dual-Stack bearers and Dual-Stack hosts IPv6-only functionality is not enough.

Dual-Stack bearers are introduced in 3GPP Release 8 for EPC and in Release 9 for GPRS. Dual-Stack means that two network layer protocol stacks such as IPv4 and IPv6 are present and may be simultaneously used. If there is a desire to offer the lightweight, network controlled RA based traffic steering functionality for Dual-Stack bearers and Dual-Stack hosts, then [RFC4191] has to be enhanced with minimal support for IPv4 router prioritization and a mechanism to identify IPv4 routers.

In one scenario, the Dual-Stack capable router, or a Dual-Stack capable host with Internet Protocol (IP) traffic forwarding capability, on the network side has IPv6 and IPv4 router functions/interfaces collocated. This applies in EPC and GPRS cases, for example. Although the IPv6 and IPv4 router functionality in Dual-Stack case may be collocated, the way how hosts (UE) discover the router is very different in IPv6 case compared to IPv4 case.

In IPv6 the host learns its default routers from the source IPv6 address where the RA originated. In IPv4 case the host typically learns its default gateway (router) from DHCPv4 (DHCP: Dynamic Host Configuration Protocol) or by another configuration. According to [RFC1256], it is defined an ICMP based router discovery (ICMP: Internet Control Message Protocol) for IPv4 but that is hardly used in practice, at least not by end hosts. Thus, IPv6 and IPv4 use their own mechanism of address resolution for learning Layer-2 address of the first hop or next hop routers, wherein the mechanisms are incompatible. Thus, a single way of describing/conveying information about the layer 2 address of a collocated IPv6/IPv4 functionality is needed.

In this context, the naming and numbering of layers follows the Open Systems Interconnection (OSI) layer model defining the following seven layers:
Layer 1: Physical Layer;
Layer 2: Link Layer;
Layer 3: Network Layer;
Layer 4: Transport Layer;
Layer 5: Session Layer;
Layer 6: Presentation Layer;
Layer 7: Application Layer.

In case of Point-to-Point links (like 3GPP links/bearers) there is no need for address resolution. However, there is still need for knowing the IP address of the first hop or next hop router. From a stack implementation point of view, finding out the default router in GPRS/EPC case is feasible for a Point-to-point link. In fact, there is no need for finding out the default router because the stack implementation may just dump all packets into the Point-to-point link without caring about “unnecessary IP level” details. However, that works only for certain types of link models but it is not really a protocol feature and does not correspond to the way interoperability of protocols is usually achieved. Thus, a way to have a single way of describing/conveying such information from a collocated IPv6/IPv4 router is needed.

One could use DHCPv4 to convey information of the default IPv4 router/gateway to the end host (UE) but especially in GPRS and EPC, the use of DHCP in general is not preferred although it is specified. Also having two different protocols to configure IP related information that originates from or concerns the same collocated router is not desired. Thus, a way to have a single way of describing/conveying information from collocated IPv6/IPv4 information is needed.

Using the mechanisms according to [RFC4191], one may convey IPv4 routes as IPv4-mapped (or even IPv4-compatible) IPv6 addresses. In this case, when an IPv6 stack receives these “IPv4” routes, they are installed into the IPv6 side of the routing table in the host. When a Dual-Stack capable application opens a socket and uses IPv4-mapped addresses (as it usually happens when resolving destination addresses using Domain Name System (DNS) and using IPv6 compatible resolver libraries, as many operating systems provide today by default), the IPv6 stack notices the destination is actually an IPv4 destination and immediately internally calls IPv4 stack side functions. After that, the default router selection and routing decision is made using IPv4 routing table and IPv4 default router lists. This causes that all valuable information (such as preference levels) of a “pure” [RFC4191] enhanced RA is neglected.

In some scenarios, a stack may have heuristics to install routes and somehow figure out the preference for IPv4 side of the stack. However, in this case finding out the IPv4 address of the router becomes an issue (on other link types than Point-to-point links, especially on Ethernet type of shared media links). Reverse Address Resolution Protocol (RARP) may be used to find the router's IPv4 address based on the IPv6 Source Link-Layer Address Option (SLLAO) link-layer address. However, such a heuristic may be prone to problems and it is not even mandatory to have SLLAO in a RA. Thus the solution needs a deterministic way to learn the IPv4 address of the collocated IPv4 router and a way to associate the IPv6 side link-layer address to the IPv4 address without a need to do ARP.

[RFC1256] and [RFC2131] both describe how to learn the first hop router for IPv4. [RFC3442] describes how to define more specific routes for IPv4 traffic.

[RFC1256] uses a method that is not part of host stack usually. Also it adds a new flavour of protocol for router discovery and lacks the functionality for more specific route definitions and therefore does not fit as-is without modifications. Actually the [RFC1256] message format does not allow new extensions, thus it is not possible to add more specific route information into it.

[RFC2131] and [RFC3442] both use DHCPv4 which is not preferred in cellular deployments. Having two different protocols to do the similar things (e.g. making a dual-stack host aware of the layer 2 address of the first hop router which may be a dual stack router) is not desired either.

### SUMMARY OF THE INVENTION

It is an object of the present invention to improve the prior art.

In detail, the handling of multiple interfaces and traffic flow steering between different interfaces for Multiple-Stack enabled hosts is improved by way of using Router Advertisements (RA). More particularly, it is addressed how the network may instruct a Multiple-Stack host (e.g. a Dual-Stack host) to move IPv4 traffic between different interfaces using Router Advertisements as a way to instruct more specific routes to the host.

According to a first aspect of the invention, there is provided an apparatus, comprising advertisement receiving means adapted to receive an advertisement message according to a first network layer protocol, wherein the advertisement message comprises a flag, a network layer address according to a second network layer protocol different from the first network layer protocol, and a first link layer address; flag detecting means adapted to detect if the flag is set in the advertisement message; routing table setting means adapted to set the first link layer address as a router address in a routing table of the second network layer protocol if the flag is set; and directing means adapted to direct a message of the second network layer protocol to the router address as a first hop router.

The apparatus may further comprise address resolving means adapted to resolve a second link layer address related to the network layer address if the flag is not set; and the routing table setting means may be further adapted to set the second link layer address as the router address if the flag is not set.

The apparatus may additionally comprise type detecting means adapted to detect if the advertisement message is of a specific type; and the flag detecting means may be adapted to detect if the flag is set only if the advertisement message is of the specific type.

The apparatus may further comprise lifetime determining means adapted to determine a lifetime based on an indication comprised in the advertisement message; and the routing table setting means may be adapted to set the router address only if the lifetime is not elapsed.

The apparatus may further comprise routing metric determining means adapted to determine a routing metric based on a preference level indicated in the advertisement message; and routing metric setting means adapted to set the routing metric for the router address in the routing table.

In the apparatus, the first network layer protocol may comprise internet protocol v6, and the second network layer protocol may comprise internet protocol v4.

According to a second aspect of the invention, there is provided an apparatus, comprising advertisement receiving processor adapted to receive an advertisement message according to a first network layer protocol, wherein the advertisement message comprises a flag, a network layer address according to a second network layer protocol different from the first network layer protocol, and a first link layer address; flag detecting processor adapted to detect if the flag is set in the advertisement message; routing table setting processor adapted to set the first link layer address as a router address in a routing table of the second network layer protocol if the flag is set; and directing processor adapted to direct a message of the second network layer protocol to the router address as a first hop router.

The apparatus may further comprise address resolving processor adapted to resolve a second link layer address related to the network layer address if the flag is not set; and the routing table setting processor may be further adapted to set the second link layer address as the router address if the flag is not set.

The apparatus may additionally comprise type detecting processor adapted to detect if the advertisement message is of a specific type; and the flag detecting processor may be adapted to detect if the flag is set only if the advertisement message is of the specific type.

The apparatus may further comprise lifetime determining processor adapted to determine a lifetime based on an indication comprised in the advertisement message; and the routing table setting processor may be adapted to set the router address only if the lifetime is not elapsed.

The apparatus may further comprise routing metric determining processor adapted to determine a routing metric based on a preference level indicated in the advertisement message; and routing metric setting processor adapted to set the routing metric for the router address in the routing table.

In the apparatus, the first network layer protocol may comprise internet protocol v6, and the second network layer protocol may comprise internet protocol v4.

According to a third aspect of the invention, there is provided a host comprising an apparatus according to any of the first and second aspects.

According to a fourth aspect of the invention, there is provided an apparatus, comprising first routing means adapted to route a first message according to a first network layer protocol, the first routing means having a first network layer address according to the first network layer protocol and a first link layer address; second routing means adapted to route a second message according to a second network layer protocol different from the first network layer protocol, the second routing means having a second network layer address according to the second network layer protocol and a second link layer address; flag setting means adapted to set a flag only if the first link layer address is the same as the second link layer address; and advertising means adapted to advertise, by an advertisement message, a source address, the second network layer address, and the flag, wherein the source address of the advertisement message is the first link layer address.

In the apparatus, the advertisement message may include at least one of an indication about its type, a lifetime of the second link layer address, and a preference.

In the apparatus, the first network layer protocol may comprise internet protocol v6, and the second network layer protocol may comprise internet protocol v4.

According to a fifth aspect of the invention, there is provided an apparatus, comprising first routing processor adapted to route a first message according to a first network layer protocol, the first routing processor having a first network layer address according to the first network layer protocol and a first link layer address; second routing processor adapted to route a second message according to a second network layer protocol different from the first network layer protocol, the second routing processor having a second network layer address according to the second network layer protocol and a second link layer address; flag setting processor adapted to set a flag only if the first link layer address is the same as the second link layer address; and advertising processor adapted to advertise, by an advertisement message, a source address, the second network layer address, and the flag, wherein the source address of the advertisement message is the first link layer address.

In the apparatus, the advertisement message may include at least one of an indication about its type, a lifetime of the second link layer address, and a preference.

In the apparatus, the first network layer protocol may comprise internet protocol v6, and the second network layer protocol may comprise internet protocol v4.

According to a sixth aspect of the invention, there is provided a router, comprising an apparatus according to any of the fourth and fifth aspects.

According to a seventh aspect of the invention, there is provided a system, comprising a host apparatus according to the first aspect; and a router apparatus according to the fourth aspect; wherein the advertisement receiving means of the host apparatus is adapted to receive the advertisement message of the router apparatus.

According to an eighth aspect of the invention, there is provided a system, comprising a host apparatus according to the second aspect; and a router apparatus according to the fifth aspect; wherein the advertisement receiving processor of the host apparatus is adapted to receive the advertisement message of the router apparatus.

According to a ninth aspect of the invention, there is provided a method, comprising receiving an advertisement message according to a first network layer protocol, wherein the advertisement message comprises a flag, a network layer address according to a second network layer protocol different from the first network layer protocol, and a first link layer address; detecting if a flag is set in the advertisement message; setting the first link layer address as a router address in a routing table of the second network layer protocol if the flag is set; and directing a message of the second network layer protocol to the router address as a first hop router.

The method may be a host method.

The method may further comprise resolving a second link layer address related to the network layer address if the flag is not set; and setting the second link layer address as the router address if the flag is not set.

The method may additionally comprise detecting if the advertisement message is of a specific type; wherein it may be detected only if the flag is set if the advertisement message is of the specific type.

The method may further comprise determining a lifetime based on an indication comprised in the advertisement message; and the router address may be set only if the lifetime is not elapsed.

The method may further comprise determining a routing metric based on a preference level indicated in the advertisement message; and setting the routing metric for the router address in the routing table.

In the method, the first network layer protocol may comprise internet protocol v6, and the second network layer protocol may comprise internet protocol v4.

According to a tenth aspect of the invention, there is provided a method, comprising routing, by a first routing means, a first message according to a first network layer protocol, the first routing means having a first network layer address according to the first network layer protocol and a first link layer address; routing, by a second routing means, a second message according to a second network layer protocol different from the first network layer protocol, the second routing means having a second network layer address according to the second network layer protocol and a second link layer address; setting a flag only if the first link layer address is the same as the second link layer address; and advertising, by an advertisement message, a source address, the second network layer address, and the flag, wherein the source address is the first link layer address.

The method may be a router method.

In the method, the advertisement message may include at least one of an indication about its type, a lifetime of the second link layer address, and a preference.

In the method, the first network layer protocol may comprise internet protocol v6, and the second network layer protocol may comprise internet protocol v4.

According to an eleventh aspect of the invention, there is provided a method, comprising a host method according to the ninth aspect; a router method according to the tenth aspect; wherein the advertisement message of the router method is the received message of the host method.

The method may be a routing method.

According to a twelfth aspect of the invention, there is provided a computer program product including a program comprising software code portions being arranged, when run on a processor of an apparatus, to perform the method according to any one of the ninth to eleventh aspects.

In the computer program product, the computer program product may comprise a computer-readable medium on which the software code portions are stored, and/or wherein the program may be directly loadable into a memory of the processor.

Thus, it is achieved that a similar and compatible mechanism is available for making a multiple-stack host aware of the layer 3 (network layer) and layer 2 (link layer) address of the first hop or next hop router for each of the multiple stacks. Furthermore, information about lifetime and preference levels may be obtained by the host for routers of each of the network layer protocols. Also, load on the host due to address resolving is reduced. The solution may be backwards compatible.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows an apparatus according to an embodiment of the invention;

FIG. 2 shows a method according to an embodiment of the invention;

FIG. 3 shows an apparatus according to an embodiment of the invention;

FIG. 4 shows a method according to an embodiment of the invention;

FIG. 5 shows a system according to an embodiment of the invention; and

FIG. 6 shows an RA option according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

According to an embodiment of the invention, the Dual-Stack capable router on the network side has collocated IPv6 and IPv4 router functions/interfaces. Collocated means that the IPv6 and IPv4 router functions/interfaces have the same link layer address. In other embodiments, the IPv6 and IPv4 router functions/interfaces may have different link layer addresses.

Embodiments of the invention are described with respect to a cellular (GPRS or EPC) environment. In GPRS and EPC, routing advertisement (RA) is used to configure the IPv6 side of a UE's IP configuration. In GPRS and EPC, the 3GPP link may be considered as a “trusted” and operator controlled/managed radio connection/interface, also called “commanding” interface. The operator may preferably use it to dynamically send its traffic steering RAs to an end host (UE).

According to embodiments of the invention, the existing [RFC4191] protocol and its capabilities, i.e. in particular the Router Advertisement (RA), is leveraged to
1. include the IPv4 address of the Dual-Stack router that originated the RA, and to
2. add a way to associate the [RFC4861] SLLAO included link-layer address with the above mentioned IPv4 router address.

Using the above information, one may use RAs to convey specific routes for IPv4 traffic in an equivalent way as for IPv6 traffic. This is possible because IPv4-mapped (or even the deprecated IPv4-compatible) IPv6 addresses may be encoded into [RFC4191] more specific route options included in RAs.

In addition, the RA may comprise information to allow
3. Associating route metric information and lifetime to the above IPv4 router address to mimic the three level preference capabilities of [RFC4191] for IPv6 routers.

As the IPv4 lacks the similar “default router” list as according to IPv6, the router metric (among other implementation dependent weights/metrics) is used for a coarse prioritization of routers, if multiple routers exist. The prefix “preference” according to IPv6 may be mapped inside the host stack to IPv4 metric values. Such a mapping could be e.g.:
High (01)->metric 0;
Medium (00)->metric 1; and
Low (11)->metric 1023

In some embodiments, depending on the host operating system's routing table implementations, the route metric may be mapped to some internal value associated with the route entry in the routing table. One example is Linux multiple routing table “index” used by policy routing.

All the above can be represented by a new RA option, whereof an example is illustrated in FIG. 6:
“Type” may be an option type code. Preferably, it may be allocated by the Internet Assigned Numbers Authority (IRNA). As an example, the type of the above RA may be V4RAO (=IPv4 Router Advertisement Option).
“Length” may be the length of the option including the Type and Length of the option, e.g. in units of 8 octets.
“Prf” defines the preference of this IPv4 router using the RFC4191 preference bits presentation.
“S” is a one-bit flag defining whether the RA's SLLAO maps directly to IPv4 routers link-layer address as well. For example, if S=1, then the SLLAO link-layer address is the same for IPv6 and IPv4. If S=0 then the host has to do address resolution to find out the link-layer address for the IPv4 router (address).
   Note that S=0 does not mean that no SLLAO mapping exists, but just that the host has to do address resolution to find the link-layer address matching the IPv4 router address. In some embodiments, the roles of S=0 and S=1 may be interchanged. Also, in some embodiments, instead of a flag, another indication providing an information corresponding to that of the “S”-flag may be employed.
“Router lifetime” may be the time the IPv4 router address can be considered valid as a possible default router. The unit may be seconds. A value of zero may mean that this IPv4 router address is not valid anymore as a default router, i.e. the route for the next hop is expired.
“Reserved” may be set to zero.
“IPv4 router address” may be a unicast IPv4 address of the router, which may be collocated with the IPv6 router where the RA originated from.

The new V4RAO option may be only available in Router Advertisement messages. The RA's IPv6 source address may be a link-local address and may originate from the same router as the IPv4 router address points to. They do not need to be the same physical interface, for example in a case where S=0.

When a host receives the V4RAO option in a RA and the router lifetime is greater than zero, it may update route entries in the IPv4 routing table by installing more specific routes it learned from the RA (in IPv4-mapped or IPv4-compatible form) to the routing table using the IPv4 router address learned from the V4RAO option described above as the next hop router. If the RA also included a SLLAO and the S bit was set then the IPv4 side of the stack may skip address resolution (ARP) and use the link-layer address in the SLLAO as the link-layer address for the IPv4 address as well.

If the router lifetime is zero in the received V4RAO, then the host should preferably make sure that the IPv4 router address in the V4RAO is not the default gateway for IPv4 traffic. If the existing default gateway is the same as the IPv4 address in the V4RAO, the host should preferably change the default gateway to some other IPv4 router it knows or redo the default gateway determination for the desired destination.

Prf bits in the V4RAO may be used to prioritize the IPv4 router for situations where there are multiple routers on different interfaces on the host. Prf bits for IPv4-mapped (and IPv4-compatible) IPv6 addresses may be used in the similar manner in IPv4 routing table as for IPv6.

According to some embodiments, the main changes in the host stack compared to a conventional host stack may be the following:
The host stack may understand the V4RAO option.
The host stack may understand to install/remove IPv4-mapped (and IPv4-compatible) more specific routes into/from the IPv4 routing table instead of IPv6 routing table.
The host stack may use the IPv4 router address from the V4RAO RA as the next hop address for the “IPv4 more specific” routes.
If available, the Prf values in the V4RAO RA may be mapped to meaningful IPv4 stack side metric values.

The V4RAO with described host stack modifications may be used to implement RFC4191 type of functionality for Dual-Stack hosts.

According to some embodiments of the invention, an RFC4191 RA based mechanism may be used to implement e.g. operator/network controlled WLAN offload solution for hosts with 1) Dual-Stack and 2) multiple interfaces (3GPP+WLAN). The traffic steering is independent for both IPv4 and IPv6 flows. In detail, WLAN offloading for IPv4 traffic according to embodiments of the invention may be achieved as follows:

In such embodiments, both 3GPP radio and WLAN interfaces are available and the WLAN interface has both IPv6 & IPv4 connectivity set up. The 3GPP radio interface is the “commanding interface”, i.e. more specific route information and router preferences are only respected when learned from RAs received from the 3GPP radio interface.

A Dual-Stack router on the “commanding interface” may prepare a RA with V4RAO option. The RA contains an SLLAO option. The RA (V4RAO) points to the IPv4 address of the Dual-Stack router (e.g. 10.6.6.6) and the flag S=1 is set in the RA (V4RAO). The lifetime in the RA (V4RAO) may be set to the same as for the IPv6 default router. The V4RAO prf may be set to 11b (low preference). More specific “IPv4 routes” are set for 192.0.2.0/24, which means a route information option with a prefix “::ffff:192.0.2.0/120” is added into the RA.

The Dual-Stack router sends the RA to the UE. Upon receiving the RA, the UE known the layer-2 address of the IPv4 router (i.e. 10.6.6.6) equals the link-layer address received in the SLLAO option (because of S=1).

Because the “prf” for the IPv4 router in V4RAO is “low”, the UE makes sure that the default gateway for IPv4 is the one learned via WLAN interface. This may be achieved with manipulating the IPv4 routing table and route metrics. All IPv4 traffic without specific routes gets now routed to WLAN interface.

The UE may install a specific IPv4 route for 192.0.2.0/24 into the IPv4 routing table instead of IPv6 routing table pointing to 10.6.6.6 in the 3GPP radio interface. This causes all traffic destined to 192.0.2.0/24 to be forwarded to the 3GPP radio interface instead of to the WLAN interface (netmask 24 results from the formula 32-(128-prefix length in route information option).

In such embodiments of WLAN offloading, IPv6 traffic handling is still completely independent from IPv4 traffic handling.

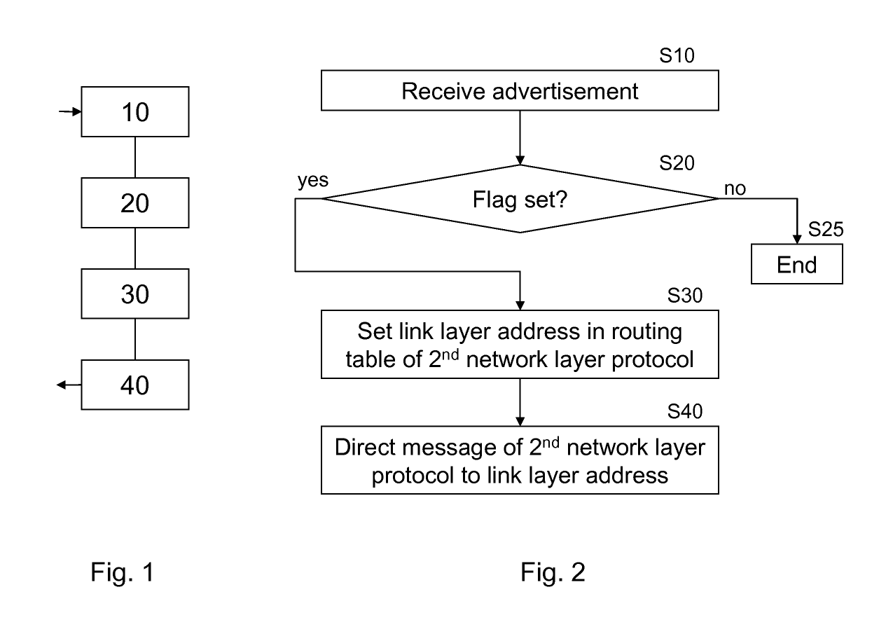

FIG. 1 shows an apparatus according to an embodiment of the invention. The apparatus may be a host. FIG. 2 shows a method according to an embodiment of the invention. The apparatus according to FIG. 1 may perform the method of FIG. 2 but is not limited to this method. The method of FIG. 2 may be performed by the apparatus of FIG. 1 but is not limited to being performed by this apparatus.

The apparatus comprises an advertisement receiving means 10, a flag detecting means 20, a routing table setting means 30, and a directing means 40.

According to step S10 which may be performed by the advertising receiving means 10, a router advertisement (RA) according to a first network layer protocol is received. The first network layer protocol may be IPv6. The RA comprises a flag and a network layer address according to a second network layer protocol such as IPv4, which is different from the first network layer protocol. The IPv6 link-local address of the RA may be a link-layer address of a router sending the RA.

The flag detecting means 20 may detect whether or not a flag is set (step S20). If the flag is not set, the method ends (step S25). In some embodiments, the apparatus may then perform address resolution to obtain the link layer address of the IPv4 router (not shown).

If the flag is set, the routing table setting means 30 may extract the network layer address comprised in the RA and set the link-local address of the RA as a router address (link-layer address) of a router having the network layer address in a routing table of the second network layer protocol (step S30). In some embodiments, before setting the router address, a lifetime comprised in the RA will be checked, and the router address will be set only if the lifetime has not expired (not shown). In some embodiments, the network layer address comprised in the RA must be decoded into a format according to the second network layer protocol before it is added to the routing table.

If a data packet according to the second network layer protocol is to be transmitted by the apparatus, the directing means 40 may look up the router address in the routing table and instruct transmission of the packet to the stored link-layer address (step S40).

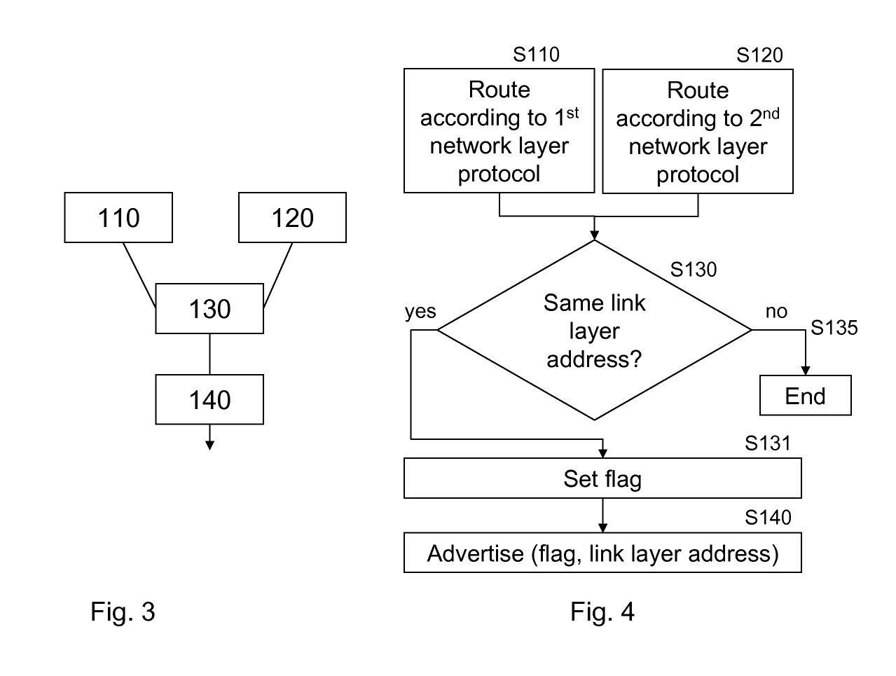

FIG. 3 shows an apparatus according to an embodiment of the invention. The apparatus may be a router. FIG. 4 shows a method according to an embodiment of the invention. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises a first routing means 110, a second routing means 120, a flag setting means 130, and an advertising means 140.

According to step S110, which may be performed by the first routing means 110, a message is routed according to a first network layer protocol, such as IPv6. The first routing means 110 has a network layer address according to the first network layer protocol, and a link layer address.

According to step S120, which may be performed by the second routing means 120, another message is routed according to a second network layer protocol, such as IPv4. The second network layer protocol is different from the first network layer protocol. The second routing means 120 has a network layer address according to the second network layer protocol, and a link layer address.

The flag setting means 130 may set a flag only if the link layer addresses of the first and second routing means are the same (step S130).

The advertising means 140 advertises the network layer address of the second routing means 120 (step S140) and the flag. A source address of such an advertisement message may be the link layer address of the first routing means 110.

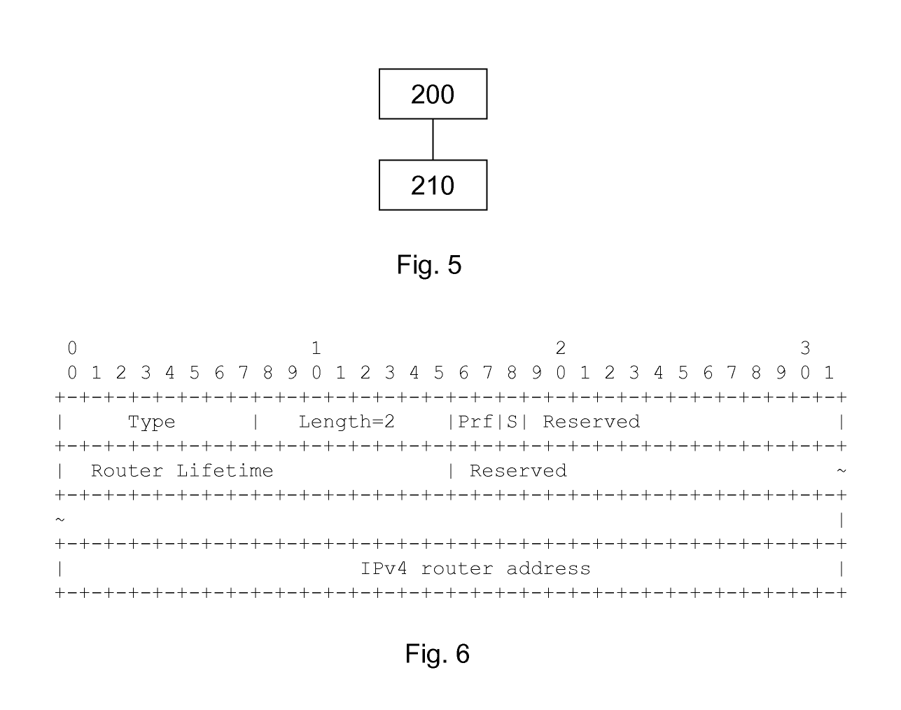

FIG. 5 shows a system according to an embodiment of the invention. The system comprises a host 200 and a router 210. The host may be an apparatus as described with respect to FIG. 1. The router may be an apparatus as described with respect to FIG. 3. That is, one of both of the host and the router may be embodiments of the invention. The advertising receiving means of the host 200 is adapted to receive the advertisement message of the advertising means of the router. Thus, the system may perform the method as generally described hereinabove.

Embodiments of the invention are described with respect to EPC and GPRS networks. However, in some embodiments, instead of these networks, other radio networks and even wired networks, such as an asynchronous transfer mode (ATM) network or a Frame Relay (FR) network, may be employed, provided that the network supports dual or multiple stacks on the network layer.

In some embodiments, the RAs are transmitted over a Point-to-Point link. However, in other embodiments, the RAs may be transmitted over links of other link models such as multicast capable links or shared media links. The router and the host may be on a same link or one link may be a “commanding” interface in the sense discussed above. In radio networks, preferably the radio interface is the “commanding” interface.

Some embodiments are described with IPv4 and IPv6 as network layer protocols of the dual stack. In some embodiments, one or both of these protocols may additionally comprise e.g. ICMP, internet protocol security (IPsec), or internet group management protocol (IGMP), and their different versions as network layer protocols.

If not otherwise stated or otherwise made clear from the context, the statement that two entities are different means that they are differently addressed in the communication network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a host, or a component thereof, an apparatus embodying the same, a method for controlling and/or operating the same, and computer program(s) controlling and/or operating the same as well as mediums carrying such computer program(s) and forming computer program product(s). Further exemplary embodiments of the present invention provide, for example a router, or a component thereof, an apparatus embodying the same, a method for controlling and/or operating the same, and computer program(s) controlling and/or operating the same as well as mediums carrying such computer program(s) and forming computer program product(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. Apparatus, comprising
advertisement receiving means adapted to receive an advertisement message according to a first network layer protocol, wherein the advertisement message comprises a flag, a network layer address according to a second network layer protocol different from the first network layer protocol, and a first link layer address;
flag detecting means adapted to detect if the flag is set in the advertisement message;
routing table setting means adapted to set the first link layer address as a router address in a routing table of the second network layer protocol if the flag is set; and
directing means adapted to direct a message of the second network layer protocol to the router address as a first hop router.

2. The apparatus according to claim 1, further comprising
address resolving means adapted to resolve a second link layer address related to the network layer address if the flag is not set; wherein
the routing table setting means is further adapted to set the second link layer address as the router address if the flag is not set.

3. The apparatus according to claim 1, additionally comprising
type detecting means adapted to detect if the advertisement message is of a specific type; and wherein
the flag detecting means is adapted to detect if the flag is set only if the advertisement message is of the specific type.

4. The apparatus according to claim 1, further comprising
lifetime determining means adapted to determine a lifetime based on an indication comprised in the advertisement message; and wherein
the routing table setting means is adapted to set the router address only if the lifetime is not elapsed.

5. The apparatus according to claim 1, further comprising
routing metric determining means adapted to determine a routing metric based on a preference level indicated in the advertisement message; and
routing metric setting means adapted to set the routing metric for the router address in the routing table.

6. The apparatus according to claim 1, wherein
the first network layer protocol comprises internet protocol v6, and the second network layer protocol comprises internet protocol v4.

7. Host comprising an apparatus according to claim 1.

8. Apparatus, comprising
first routing means adapted to route a first message according to a first network layer protocol, the first routing means having a first network layer address according to the first network layer protocol and a first link layer address;
second routing means adapted to route a second message according to a second network layer protocol different from the first network layer protocol, the second routing means having a second network layer address according to the second network layer protocol and a second link layer address;
flag setting means adapted to set a flag only if the first link layer address is the same as the second link layer address; and
advertising means adapted to advertise, by an advertisement message, a source address, the second network layer address, and the flag, wherein the source address of the advertisement message is the first link layer address.

9. The apparatus according to claim 8, wherein the advertisement message includes at least one of an indication about its type, a lifetime of the second link layer address, and a preference.

10. The apparatus according to claim 8, wherein
the first network layer protocol comprises internet protocol v6, and the second network layer protocol comprises internet protocol v4.

11. Router, comprising an apparatus according to claim 8.

12. System, comprising
a host apparatus according to claim 1; and
a router apparatus comprising
first routing means adapted to route a first message according to a first network layer protocol, the first routing means having a first network layer address according to the first network layer protocol and a first link layer address;
second routing means adapted to route a second message according to a second network layer protocol different from the first network layer protocol, the second routing means having a second network layer address according to the second network layer protocol and a second link layer address;
flag setting means adapted to set a flag only if the first link layer address is the same as the second link layer address; and
advertising means adapted to advertise, by an advertisement message, a source address, the second network layer address, and the flag, wherein the source address of the advertisement message is the first link layer address;
wherein the advertisement receiving means of the host apparatus is adapted to receive the advertisement message of the router apparatus.

13. Method, comprising
receiving an advertisement message according to a first network layer protocol, wherein the advertisement message comprises a flag, a network layer address according to a second network layer protocol different from the first network layer protocol, and a first link layer address;
detecting if a flag is set in the advertisement message;
setting the first link layer address as a router address in a routing table of the second network layer protocol if the flag is set; and
directing a message of the second network layer protocol to the router address as a first hop router.

14. The method according to claim 13, further comprising
resolving a second link layer address related to the network layer address if the flag is not set; and
setting the second link layer address as the router address if the flag is not set.

15. The method according to claim 13, additionally comprising
detecting if the advertisement message is of a specific type; and wherein
it is detected only if the flag is set if the advertisement message is of the specific type.

16. The method according to claim 13, further comprising
determining a lifetime based on an indication comprised in the advertisement message; and wherein
the router address is set only if the lifetime is not elapsed.

17. The method according to claim 13, further comprising
determining a routing metric based on a preference level indicated in the advertisement message; and
setting the routing metric for the router address in the routing table.

18. The method according to claim 13, wherein
the first network layer protocol comprises internet protocol v6, and the second network layer protocol comprises internet protocol v4.

19. Method, comprising
routing, by a first routing means, a first message according to a first network layer protocol, the first routing means having a first network layer address according to the first network layer protocol and a first link layer address;
routing, by a second routing means, a second message according to a second network layer protocol different from the first network layer protocol, the second routing means having a second network layer address according to the second network layer protocol and a second link layer address;
setting a flag only if the first link layer address is the same as the second link layer address; and
advertising, by an advertisement message, a source address, the second network layer address, and the flag, wherein the source address is the first link layer address.

20. The method according to claim 19, wherein the advertisement message includes at least one of an indication about its type, a lifetime of the second link layer address, and a preference.

21. The method according to claim 18, wherein
the first network layer protocol comprises internet protocol v6, and the second network layer protocol comprises internet protocol v4.

22. Method, comprising
a host method according to claim 13;
a router method comprising
routing, by a first routing means, a first message according to a first network layer protocol, the first routing means having a first network layer address according to the first network layer protocol and a first link layer address;
routing, by a second routing means, a second message according to a second network layer protocol different from the first network layer protocol, the second routing means having a second network layer address according to the second network layer protocol and a second link layer address;
setting a flag only if the first link layer address is the same as the second link layer address; and
advertising, by an advertisement message, a source address, the second network layer address, and the flag, wherein the source address is the first link layer address;
wherein the advertisement message of the router method is the received message of the host method.

23. A computer program product including a program comprising software code portions being arranged, when run on a processor of an apparatus, to perform the method according to claim 13.

24. The computer program product according to claim 23, wherein the computer program product comprises a computer-readable medium on which the software code portions are stored, and/or wherein the program is directly loadable into a memory of the processor.
